(19) United States
(12) Patent Application Publication
(10) Pub. No.: US 2026/0135167 A1
(43) Pub. Date: May 14, 2026

(54) Fuel Cell System

(71) Applicant: TOYOTA JIDOSHA KABUSHIKI KAISHA, Toyota-shi, Aichi-ken (JP)

(72) Inventors: Shu MIZUNO, Susono-shi, Shizuoka-ken (JP); Takahiro UMEHARA, Susono-shi, Shizuoka-ken (JP)

(73) Assignee: TOYOTA JIDOSHA KABUSHIKI KAISHA, Toyota-shi, Aichi-ken (JP)

(21) Appl. No.: 18/962,383

(22) Filed: Nov. 27, 2024

(30) Foreign Application Priority Data
Jan. 17, 2024 (JP) 2024-005384

(51) Int. Cl. H01M 10/42; B60L 50/75; B60L 58/40; H01M 8/04537; H01M 16/00

(52) U.S. Cl. CPC H01M 10/425; H01M 8/04559; H01M 16/006; B60L 50/75; B60L 58/40; B60L 2240/547; H01M 2250/402

(57) ABSTRACT

The fuel cell system includes a fuel cell stack, a battery, a relay, a first voltage sensor, a second voltage sensor, and a control device. The control device is configured to be capable of executing a fixation detection process of the relay. The fixing detection process includes: giving a closing command to the relay; starting power generation of the fuel cell stack after giving a closing command to the relay; giving an opening command to the relay when the voltage obtained from the first voltage sensor becomes equal to or higher than the voltage obtained from the second voltage sensor after starting power generation; and determining that the relay is fixed when the voltage obtained from the first voltage sensor is equal to the voltage obtained from the second voltage sensor after giving the opening command to the relay.

### CROSS-REFERENCE TO RELATED APPLICATION

This application claims priority to Japanese Patent Application No. 2024-005384 filed on Jan. 17, 2024, incorporated herein by reference in its entirety.

### BACKGROUND

### 1. Technical Field

A technique disclosed herein relates to a fuel cell system.

### 2. Description of Related Art

A fuel cell system is disclosed in International Publication No. WO 2014/050346. The fuel cell system includes a fuel cell stack, a load connected in parallel with the fuel cell stack, a relay provided between the fuel cell stack and the load, a voltage sensor that detects a voltage of the load, and a control device. The control device acquires a voltage detected by the voltage sensor and controls opening and closing of the relay.

The relay described above may become inoperable while the relay remains in the closed state due to the lifetime or welding of the relay caused by excessive current flow. In the present specification, such an abnormality of the relay is referred to as fixation. In this regard, the control device of WO 2014/050346 is configured to be capable of performing a process of detecting whether a relay is fixed or not.

### SUMMARY

In the technique of WO 2014/050346, it is necessary to control not only the fuel cell system but also the operation of the load in order to detect the fixation of the relay. In order to achieve a highly versatile fuel cell system that allows a combination with various loads, there is a need for a technique capable of detecting the fixation of a relay without using the load.

In view of the above circumstances, the present specification provides a technique for detecting the fixation of a relay in a fuel cell system without using a load.

The technique disclosed herein is embodied in a fuel cell system. This fuel cell system includes:
a fuel cell stack;
a battery that is connected in parallel with the fuel cell stack and has a maximum output voltage lower than an open voltage of the fuel cell stack;
a relay that is provided between the fuel cell stack and the battery;
a first voltage sensor that is provided between the relay and the fuel cell stack and detects a voltage of the fuel cell stack;
a second voltage sensor that is provided between the relay and the battery and detects a voltage of the battery; and
a control device that acquires a voltage detected from each of the first voltage sensor and the second voltage sensor, and controls opening and closing of the relay.

The control device is configured to be able to execute a fixation detection process of the relay.

The fixation detection process includes:
giving a closing command to the relay;
starting power generation of the fuel cell stack after giving a closing command to the relay;
giving an opening command to the relay when the voltage acquired from the first voltage sensor becomes equal to or higher than the voltage acquired from the second voltage sensor after starting the power generation; and
determining that the relay is fixed when the voltage acquired from the first voltage sensor is equal to the voltage acquired from the second voltage sensor after giving an opening command to the relay.

In the fuel cell system described above, a fixation detection process of a relay interposed between the fuel cell stack and the battery is executed. In the fixation detection process, a closing command is first given to the relay, and the fuel cell stack is connected in parallel with the battery via the relay. Thereafter, when power generation of the fuel cell stack is started, the voltage of the fuel cell stack increases, but since the fuel cell stack is connected in parallel with the battery, the voltage of the fuel cell stack becomes equal to the voltage of the battery. Since the maximum output voltage of the battery is lower than the open circuit voltage of the fuel cell stack, the voltage of the battery is lower than the open circuit voltage of the fuel cell stack. When the voltage of the fuel cell stack becomes equal to the voltage of the battery, an opening command is given to the relay. At this time, when the relay is not fixed, the relay is opened, and the voltage of the fuel cell stack continuing power generation becomes higher than the voltage of the battery. On the other hand, when the relay is fixed, the relay is not opened and remains in the closed state, and the voltage of the fuel cell stack is maintained in a state of being equal to the voltage of the battery even though the power generation is continued. In this way, the fuel cell system can detect the fixation of the relay by monitoring the voltage of the fuel cell stack and the voltage of the battery after the opening command is given to the relay. That is, the fuel cell system can detect the fixation of the relay without using a load.

In a second aspect, in the first aspect,
when the state in which the voltage acquired from the first voltage sensor becomes equal to the voltage acquired from the second voltage sensor is continued for a predetermined time, determination may be made that the relay is fixed.

According to such a configuration, it is possible to accurately detect that the relay is fixed.

In a third aspect, in the first or second aspect,
the control device may execute the fixation detection process when the fuel cell stack is activated.

According to such a configuration, it is possible to execute the fixation detection process of the relay prior to the operation of the fuel cell stack.

In a fourth aspect, in any one of the first to third aspects,
the control device may execute the fixation detection process at the end of the operation of the fuel cell stack, and may store the result of the fixation detection process until the next activation of the fuel cell stack.

According to such a configuration, it is possible to reduce processes executed at the time of activation of the fuel cell stack.

In a fifth aspect, in any one of the first to fourth aspects, the fuel cell system may further include
a diode that suppresses a current flowing from the battery to the fuel cell stack.

According to such a configuration, when the voltage of the fuel cell stack is lower than the voltage of the battery, it is possible to suppress the current from the battery to the fuel cell stack. Accordingly, it is possible to accurately detect the voltage of the fuel cell stack immediately after the start of power generation by using the first voltage sensor provided between the relay and the fuel cell stack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating a configuration of a fuel cell system 10 according to an embodiment;

FIG. 2 is a flow chart showing an exemplary fixation detecting process executed by the control device 14; and

FIG. 3 shows an exemplary change in the voltage V1 of the fuel cell stack 12 and the voltage V2 of the battery 16 in the fixation detecting process.

### DETAILED DESCRIPTION OF EMBODIMENTS

The fuel cell system 10 of the present embodiment will be described with reference to the drawings. The fuel cell system 10 of the present embodiment functions as a power supply for supplying electric power to the outside. As an example, the fuel cell system 10 is a stationary fuel cell system, and is fixedly disposed at a predetermined position. However, as another embodiment, the fuel cell system 10 may be mounted on a moving object such as a fuel cell electric vehicle and function as a power source for supplying electric power to the traveling motor. The fuel cell system 10 of the present embodiment has high versatility and can be used in combination with various loads.

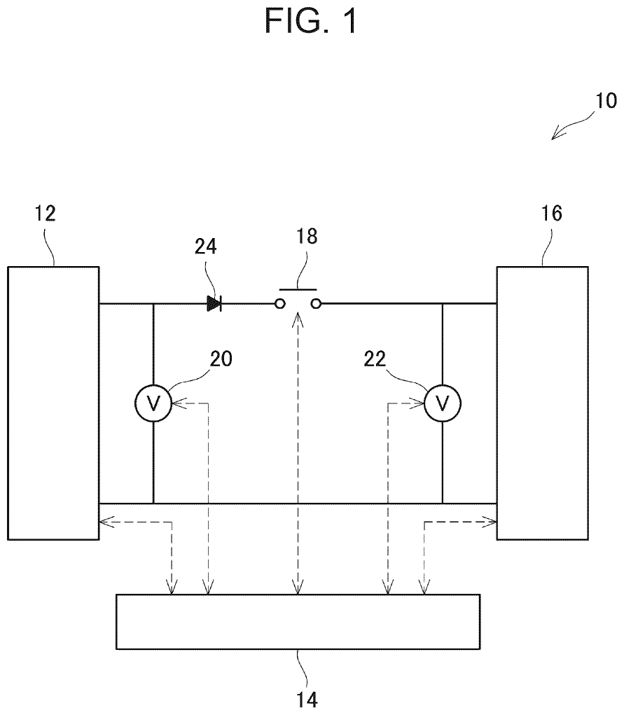

As shown in FIG. 1, the fuel cell system 10 includes a fuel cell stack 12. The fuel cell stack 12 has a structure in which a plurality of fuel cells is stacked. The fuel cell stack 12 generates electric power by chemically reacting a fuel gas and an oxidizing gas in a plurality of fuel cell cells. As an example, in the fuel cell system 10 of the present embodiment, hydrogen gas is used as the fuel gas, and air is used as the oxidizing gas. The cooling system of the fuel cell system 10 is not particularly limited, and may be an air-cooling system in which ambient air is used as a refrigerant or a water-cooling system in which coolant is circulated.

As shown in FIG. 1, the fuel cell system 10 further includes a control device 14. The control device 14 is a computer device including a processor, a memory, and the like. The control device 14 is communicatively coupled to the fuel cell stack 12 and can control and monitor the operation of the fuel cell stack 12. The control device 14 calculates the required power to the fuel cell stack 12 based on the required power from the outside. Based on the calculated required power, the control device 14 controls the pressure of the hydrogen gas and the pressure of the air supplied to the fuel cell stack 12, and also controls the output power from the fuel cell stack 12. Note that the control device 14 may be constituted by a single computer device or by a combination of a plurality of computer devices.

As shown in FIG. 1, the fuel cell system 10 further includes a battery 16 and a relay 18. The battery 16 incorporates a plurality of secondary battery cells such as lithium ion battery cells, nickel-metal hydride battery cells, or all-solid-state battery cells. The full power voltage of the battery 16 is lower than the open circuit voltage VA of the fuel cell stack 12. The battery 16 is connected in parallel with the fuel cell stack 12. The relay 18 is provided between the fuel cell stack 12 and the battery 16. The opening and closing of the relay 18 is controlled by the control device 14. The control device 14 can electrically connect and disconnect the fuel cell stack 12 and the battery 16 by closing and opening the relay 18. Although not particularly limited, the control device 14 is communicably connected to the battery 16, and can control and monitor the operation of the battery 16.

As shown in FIG. 1, the fuel cell system 10 further includes a first voltage sensor 20, a second voltage sensor 22, and a diode 24. The first voltage sensor 20 is electrically connected to both ends of the fuel cell stack 12. Accordingly, the first voltage sensor 20 can detect the voltage V1 of the fuel cell stack 12. The anode of the diode 24 is connected to the positive electrode of the fuel cell stack 12. The cathode of the diode 24 is electrically connected to the positive electrode of the battery 16 via the relay 18. That is, the diode 24 energizes the current from the fuel cell stack 12 to the battery 16, while the current from the battery 16 to the fuel cell stack 12 cuts off. Therefore, when the fuel cell stack 12 is connected in parallel with the battery 16, even if the voltage V1 of the fuel cell stack 12 is lower than the voltage V2 of the battery 16, no current flows from the battery 16 toward the fuel cell stack 12. Accordingly, the first voltage sensor 20 can accurately detect the voltage V1 of the fuel cell stack 12 even immediately after the power generation of the fuel cell stack 12 is started

while the fuel cell stack 12 is connected in parallel with the battery 16.

The second voltage sensor 22 is provided between the relay 18 and the battery 16, and is electrically connected to both ends of the battery 16. Accordingly, the second voltage sensor 22 can detect the voltage V2 of the battery 16. The control device 14 is communicatively coupled to each voltage sensor 20, 22 and is capable of monitoring the voltage detected by each voltage sensor 20, 22.

Note that the position of the diode 24 is not limited to the position described in this embodiment. For example, the diode 24 may be provided between the negative electrode of the fuel cell stack 12 and the negative electrode of the battery 16. The diode 24 may be any diode that cuts off the current from the battery 16 to the fuel cell stack 12 between the first

voltage sensor 20 and the second voltage sensor 22. Alternatively, the fuel cell system 10 may include, for example, a switching element instead of the diode 24. In this case, the switching element may be turned off until the detection voltage by the first voltage sensor 20 becomes equal to the detection voltage by the second voltage sensor 22 after the activation of the fuel cell stack 12. Accordingly, the switching element can interrupt the current flowing from the battery 16 to the fuel cell stack 12.

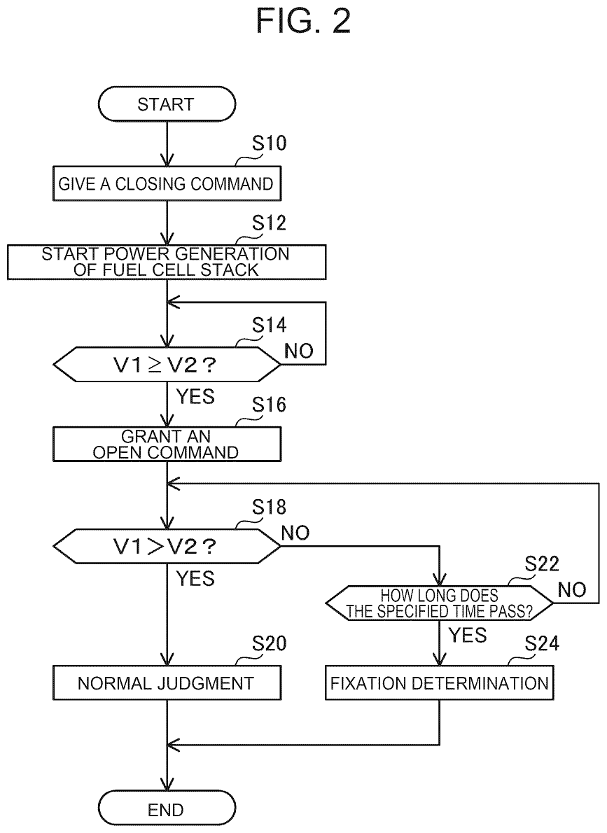

Next, a fixation detection process executed by the control device 14 will be described with reference to FIG. 2. In this fixing detection process, when the relay 18 remains in the closed state even when the opening command is received, it is detected that the relay 18 is fixed. The control device 14 according to the present embodiment is configured to start the fixation detection process when the fuel cell stack 12 is started.

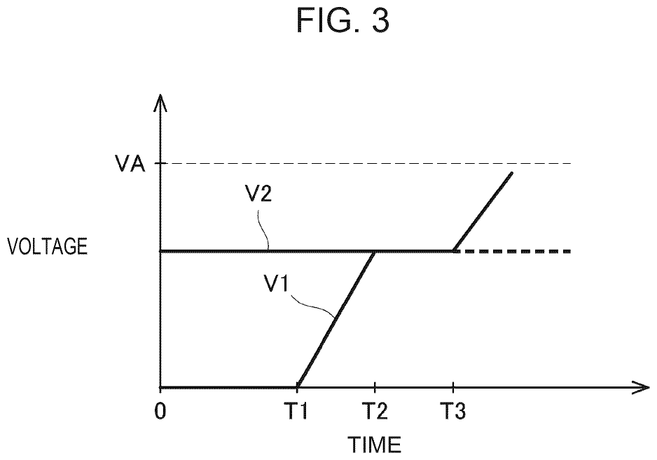

As shown in FIG. 2, the control device 14 first gives a closing command to the relays 18 (S10). Thus, the relay 18 is closed, and the fuel cell stack 12 is connected in parallel with the battery 16. Thereafter, the control device 14 starts power generation of the fuel cell stack 12 (S12). As described above, a diode 24 is interposed between the fuel cell stack 12 and the battery 16. Therefore, even when the voltage V1 of the fuel cell stack 12 is lower than the voltage V2 of the battery 16, no current flows from the battery 16 toward the fuel cell stack 12. Therefore, when power generation of the fuel cell stack 12 is started, the voltage V1 of the fuel cell stack 12 increases (time T1 in FIG. 3). On the other hand, since the maximum output voltage of the battery 16 is lower than the open circuit voltage VA of the fuel cell stack 12, the voltage V2 of the battery 16 becomes a predetermined voltage lower than the open circuit voltage VA of the fuel cell stack 12.

Next, the control device 14 determines whether the voltage V1 of the fuel cell stack 12 is equal to or higher than the voltage V2 of the battery 16 (S14). Here, the voltage V1 of the fuel cell stack 12 is the voltage obtained from the first voltage sensor 20, and the voltage V2 of the battery 16 is the voltage obtained from the second voltage sensor 22. The voltage V1 of the fuel cell stack 12 increases with the power generation of the fuel cell stack 12, but becomes equal to the voltage V2 of the battery 16 connected in parallel with the fuel cell stack 12, and thereafter (that is, after the time T2 in FIG. 3) shows a constant value.

If S14 is YES, the control device 14 gives the closing command to the relay 18 (S16) to determine whether the voltage V1 of the fuel cell stack 12 is greater than the voltage V2 of the battery 16 (S18). If the relay 18 is not fixed, the relay 18 is opened (time T3 in FIG. 3). Since the power generation of the fuel cell stack 12 continues, the voltage V1 of the fuel cell stack 12 becomes larger than the voltage V2 of the battery 16. On the other hand, when the relay 18 is fixed, the closed state of the relay 18 is maintained, so that the voltage V1 of the fuel cell stack 12 is maintained equal to the voltage V2 of the battery 16 (see the dotted line in FIG. 3). The control device 14 returns to the process of S14 if NO is selected in S14. When the relay 18 is opened, the voltage V1 of the fuel cell stack 12 and the voltage V2 of the battery 16 become open voltages, respectively, and are higher than the closed-circuit voltage before the relay 18 is opened, but in the present embodiment, the difference between the open-circuit voltage and the closed-circuit voltage is small.

If S18 is YES, the control device 14 determines that the fixing of the relays 18 has not occurred (S20), and ends the fixing determination process illustrated in FIG. 2. If NO in S18, the control device 14 determines whether the voltage V1 of the fuel cell stack 12 is equal to the voltage V2 of the battery 16 continues for a predetermined period (S22). If S22 is YES, the control device 14 determines that fixation of the relays 18 has occurred (S24), and ends the fixation determination process illustrated in FIG. 2. If S22 is NO, the control device 14 returns to S18 process.

As described above, the fuel cell system 10 of the present embodiment can execute the fixing detection process of the relay 18 interposed between the fuel cell stack 12 and the battery 16. In this fixation detecting process, the fixation of the relay 18 can be detected by monitoring the voltage V1 of the fuel cell stack 12 and the voltage V2 of the battery 16 after the release command is given to the relay 18 (that is, after the time T3 in FIG. 3). That is, according to the fixing detection process, it is possible to detect the fixing of the relay 18 without using a load.

In the above-described embodiment, in the fixing detecting process shown in FIG. 2, when the voltage V1 of the fuel cell stack 12 is equal to the voltage V2 of the battery 16 and continues for a predetermined period (YES in S22 of FIG. 2), it is determined that the relays 18 are fixed (S24). According to such a configuration, it is possible to accurately detect that the relay 18 is fixed. However, the fixation detecting process illustrated in FIG. 2 does not necessarily need to perform S22. That is, in the fixing detecting process illustrated in FIG. 2, when S18 is turned NO, it may be determined that the relays 18 are fixed (S24).

In the above-described embodiment, the control device 14 starts the fixation detection process when the fuel cell stack 12 is activated. According to such a configuration, it is possible to execute the fixing detection process of the relay 18 prior to the operation of the fuel cell stack 12.

Alternatively, the control device 14 may execute the fixing detection process at the end of the operation of the fuel cell stack 12, and store the result of the fixing detection process until the next start-up of the fuel cell stack 12. According to such a configuration, it is possible to reduce processing executed at the time of starting up the fuel cell stack 12.

In the above-described embodiment, the fuel cell system 10 includes a diode 24 that suppresses current flow from the battery 16 to the fuel cell stack 12. According to such a configuration, when the voltage V1 of the fuel cell stack 12 is lower than the voltage V2 of the battery 16, the current from the battery 16 to the fuel cell stack 12 can be suppressed. This makes it possible to accurately detect the voltage V1 of the fuel cell stack 12 immediately after power generation is started by using the first voltage sensor 20 provided between the relay 18 and the fuel cell stack 12.

The fuel cell system 10 may include, for example, a switching element instead of the above-described diode 24. In this case, the switching element may be turned off until the detection voltage by the first voltage sensor 20 becomes equal to the detection voltage by the second voltage sensor 22 after the activation of the fuel cell stack 12. Accordingly, the switching element can interrupt the current flowing from the battery 16 to the fuel cell stack 12.

While several specific examples have been described in detail above, these are merely illustrative and do not limit the scope of the claims. The technique described in the claims includes various modifications and variations of the specific examples exemplified above. The technical elements described in this specification or in the drawings may be used alone or in combination to achieve technical usefulness.

What is claimed is:

1. A fuel cell system, comprising:
a fuel cell stack;
a battery that is connected in parallel with the fuel cell stack and has a maximum output voltage lower than an open voltage of the fuel cell stack;
a relay that is provided between the fuel cell stack and the battery;
a first voltage sensor that is provided between the relay and the fuel cell stack and detects a voltage of the fuel cell stack;
a second voltage sensor that is provided between the relay and the battery and detects a voltage of the battery; and
a control device that acquires a voltage detected from each of the first voltage sensor and the second voltage sensor, and controls opening and closing of the relay, wherein
the control device is configured to able to execute a fixation detection process of the relay, and
the fixation detection process includes:
giving a closing command to the relay;
starting power generation of the fuel cell stack after giving a closing command to the relay;
giving an opening command to the relay when the voltage acquired from the first voltage sensor becomes equal to or higher than the voltage acquired from the second voltage sensor after starting the power generation; and
determining that the relay is fixed when the voltage acquired from the first voltage sensor is equal to the voltage acquired from the second voltage sensor after giving an opening command to the relay.

2. The fuel cell system according to claim 1, wherein in the fixation detection process, determination is made that the relay is fixed when a state in which the voltage acquired from the first voltage sensor becomes equal to the voltage acquired from the second voltage sensor is continued for a predetermined time.

3. The fuel cell system according to claim 1, wherein the control device executes the fixation detection process when the fuel cell stack is activated.

4. The fuel cell system according to claim 1, wherein the control device executes the fixation detection process at an end of an operation of the fuel cell stack, and stores a result of the fixation detection process until a next activation of the fuel cell stack.

5. The fuel cell system according to claim 1, wherein a diode that suppresses a current flowing from the battery to the fuel cell stack.
